(19) United States
(12) Patent Application Publication
(10) Pub. No.: US 2014/0045006 A1
(43) Pub. Date: Feb. 13, 2014

(54) BATTERY MODULE

(71) Applicant: SAMSUNG SDI CO., LTD., Yongin-City (KR)

(72) Inventors: Jong-Wook Yoon, Yongin-City (KR); Hong-Keun Choi, Yongin-City (KR)

(73) Assignee: Samsung SDI Co., Ltd., Yongin-City (KR)

(21) Appl. No.: 13/837,307

(22) Filed: Mar. 15, 2013

Related U.S. Application Data
(60) Provisional application No. 61/682,619, filed on Aug. 13, 2012.

(51) Int. Cl. H01M 2/12; H01M 2/02

(52) U.S. Cl. CPC H01M 2/1252; H01M 2/0202; H01M 2/024
USPC 429/82

(57) ABSTRACT

There is provided a battery module capable of enhancing insulation property and safety. The battery module includes two or more battery cells arranged in one direction, and each having a vent; a housing that accommodates the battery cells and has a top cover; and a sub cover that is provided to cover at least one portion of tops of the battery cells, and allows the battery cells and the top cover to be spaced apart from each other.

### CROSS-REFERENCE TO RELATED APPLICATIONS

This application claims the benefit of U.S. Provisional Application No. 61/682,619 filed Aug. 13, 2012 which is hereby incorporated by reference in its entirety.

### BACKGROUND

1. Field

An aspect of the present invention relates to a battery module, and more particularly, to a battery module capable of enhancing insulation property and safety.

2. Description of the Related Art

A high-power battery module using a non-aqueous electrolyte with high energy density has recently been developed. The high-power battery module is configured as a large-capacity battery module manufactured by connecting a plurality of battery cells in series so as to be used for driving devices, e.g., notebook computers, electric vehicles and the like, which require high power.

A battery cell includes an electrode assembly and an electrolyte, and the electrode assembly is composed of positive and negative electrode plates. The battery cell can generate energy by an electrochemical reaction of the electrode plates and the electrolyte. In this case, gas and heat may be generated from the battery cell by a side reaction of the electrochemical reaction.

### SUMMARY

Embodiments provide a battery module in which a sub cover that allows a plurality of battery cells and a housing accommodating the battery cells to be space apart from each other at a predetermined interval is interposed between tops of the battery cells and the housing, so that it is possible to enhance the insulation property between the battery cells and the housing and the safety of the battery module.

Embodiments also provide a battery module in which a sub cover is interposed between tops of a plurality of battery cells and a housing accommodating the battery cells, so that it is possible to easily discharge gas or heat generated from the battery cells without using a conventional vent cover, thereby enhancing the safety and durability of the battery module.

According to an aspect of the present invention, a battery module including: two or more battery cells arranged in one direction, and each having a vent; a housing that accommodates the battery cells and has a top cover; and a sub cover that is provided to cover at least one portion of tops of the battery cells, and allows the battery cells and the top cover to be spaced apart from each other.

The sub cover may include a base plate formed in an approximately rectangular shape, and an insulating rib provided on the base plate so as to form a predetermined angle with the base plate at a portion contacting the housing.

The insulating rib may include a first insulating rib provided to one end of the base plate and a second insulating rib provided at the other end of the bate base plate. The first insulating rib may be protruded in a first direction with respect to the base plate, and the second insulating rib may be protruded in a second direction that is a direction opposite to the first direction.

The sub cover may include a vent rib provided in parallel with the base plate around the vent.

The vent rib may include a first vent rib protruded in the first direction with respect to the base plate and a second vent rib protruded in the second direction with respect to the base plate. The first and second vent ribs may be provided not to cover the vent.

The sub cover may further include a support rib. The support rib may be disposed between the vent rib and the insulating rib. The support rib may include a first support rib connected to the first vent rib and a second support rib connected to the second vent rib.

One portion of the first support rib may be protruded from the first vent rib so as to form a predetermined angle with the first vent rib, and the other portion of the first support rib may be protruded from the base plate so as to form a predetermined angle with the base plate.

One portion of the second support rib may be protruded from the second vent rib so as to form a predetermined angle with the second vent rib, and the other portion of the second support rib may be protruded from the base plate so as to form a predetermined angle with the base plate.

The one and the other portions of the first support rib may be connected to form a ‘ [symbol] ’ shape, and the one and the other portions of the second support rib may be connected to form a ‘ [symbol] ’ shape.

The sub cover may further include a reinforcing rib. The reinforcing rib may be provided between the insulating rib and the vent rib. The reinforcing rib connects between the base plate and the support rib so as to form a predetermined angle with the base plate or the support rib.

The reinforcing rib may include a first reinforcing rib provided to contact the first support rib and a second reinforcing rib provided to contact the second support rib. Thus, the first and second support ribs can reinforce the rigidities of the first and second support ribs, respectively.

One end of the first reinforcing rib may contact the first support rib so as to form a predetermined angle with the first support rib, and the other end of the first reinforcing rib may contact the base plate so as to form a predetermined angle with the base plate. One end of the second reinforcing rib may contact the second support rib so as to form a predetermined angle with the second support rib, and the other end of the second reinforcing rib may contact the base plate so as to form a predetermined angle with the base plate.

The reinforcing rib may be provided with one or more reinforcing ribs at the other portion of the support rib.

The sub cover may further include an anti-bending rib protruded along the long side of the base plate so as to form a predetermined angle with the base plate. Thus, it is possible to prevent the base plate from being bent along the long side of the base plate.

Projection portions may be provided to one and the other portion of the base plate, respectively.

The housing may include a bottom cover fastened to the top cover so as to accommodate the battery cells.

An opening formed at a position corresponding to the projection portion so as to be fastened to the projection portion and a through-hole portion that exposes a separate space between adjacent battery cells may be further formed in the bottom cover.

The bottom cover may include a bottom cover plate in which a bottom cover fastening hole fastened to the top cover is formed, a bottom cover projection protruded from a bottom surface of the bottom cover plate, and a connection plate connected to an adjacent battery module.

The bottom cover projection of the bottom cover and the projection of the sub cover may be provided opposite to each other in the separate space between the adjacent battery cells.

The insulating rib and the support rib may have the same height, and the height of the anti-bending rib may be lower than that of the insulating rib.

The thickness of each of the insulating rib, the support rib, the reinforcing rib and the anti-bending rib may be formed thicker than that of the base plate.

According to the present invention, it is possible to provide a battery module in which a sub cover that allows a plurality of battery cells and a housing accommodating the battery cells to be space apart from each other at a predetermined interval is interposed between tops of the battery cells and the housing, so that it is possible to enhance the insulation property between the battery cells and the housing and the safety of the battery module.

Further, it is possible to provide a battery module in which a sub cover is interposed between tops of a plurality of battery cells and a housing accommodating the battery cells, so that it is possible to easily discharge gas or heat generated from the battery cells without using a conventional vent cover, thereby enhancing the safety and durability of the battery module.

Accordingly, the sub cover with a simple structure can be substituted for the conventional barrier between battery cells and the conventional vent cover with a complicated structure, so that it is possible to simplify the manufacturing process of the battery module and to reduce manufacturing cost.

In another aspect, the aforementioned needs are satisfied by a battery module of the present invention which comprises a plurality of battery cells having a length, a width, a first surface and a vent formed in the first surface. In this aspect the battery module also comprises a housing having side walls that defines a recess having a length and a width wherein the recess receives the plurality of battery cells and a top cover that is positioned on the first housing member so as to cover the recess. In this aspect the battery module also comprises at least one sub-cover having a first and a second side that extends over at least some of the first surface of the plurality of battery cells wherein the at least one sub-cover includes a protrusion formed on the first side that is interposed between adjacent battery cells positioned within the recess so as to define a space between adjacent battery cells.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a perspective view of a battery module according to an embodiment of the present invention.

FIG. 2 is an exploded perspective view of FIG. 1.

FIG. 3 is a side view of FIG. 1.

FIG. 4 is a perspective view of the battery module excluding a housing according to the embodiment of the present invention.

FIG. 5 is a side view of portion A in FIG. 4.

FIG. 6A is a perspective view of a sub cover enlarged in one direction according to the embodiment of the present invention.

FIG. 6B is a perspective view of the sub cover enlarged in another direction according to the embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements. In the drawings, the thickness or size of layers are exaggerated for clarity and not necessarily drawn to scale.

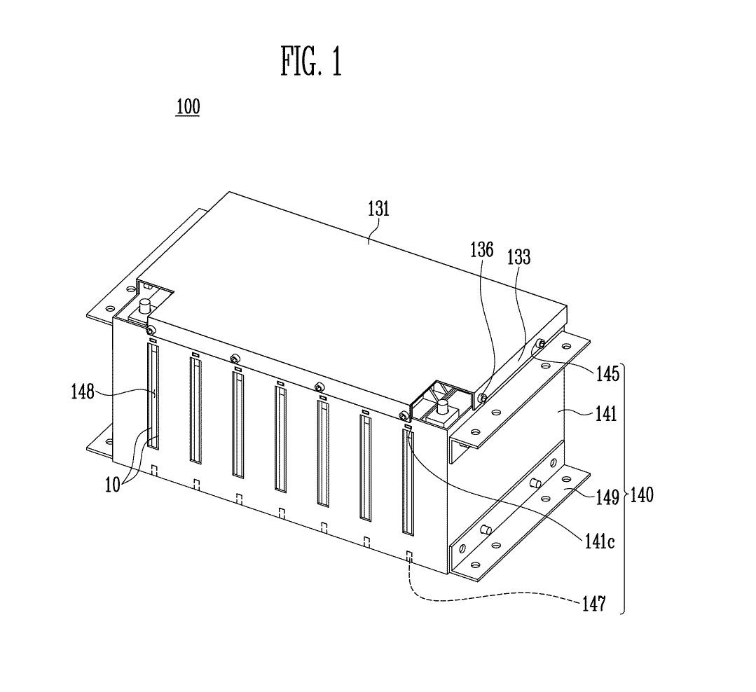

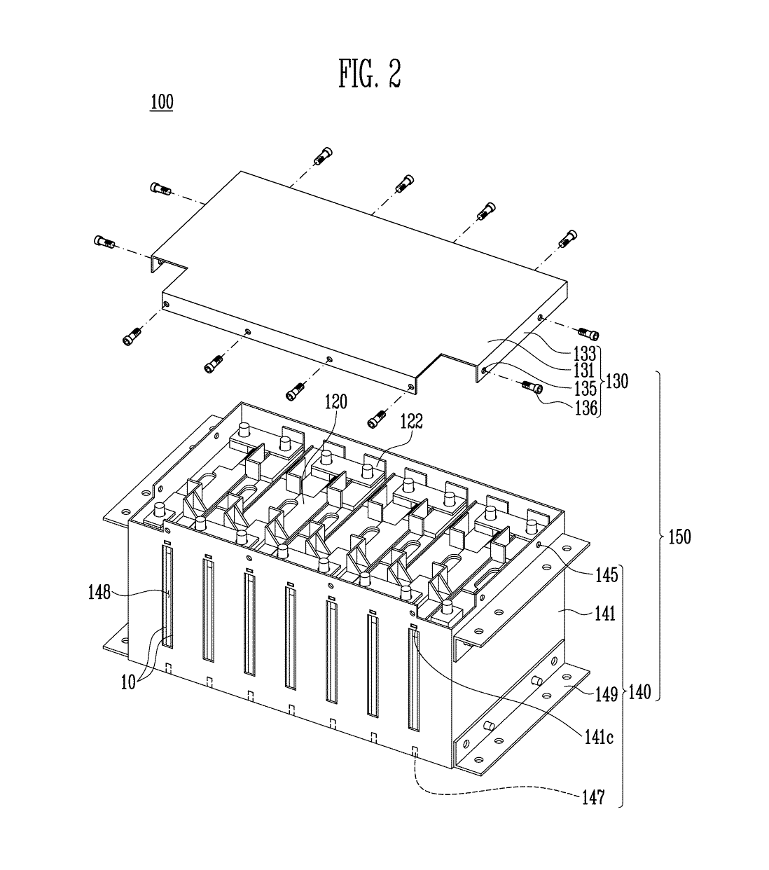

FIG. 1 is a perspective view of a battery module according to an embodiment of the present invention. FIG. 2 is an exploded perspective view of FIG. 1. FIG. 3 is a side view of FIG. 1.

Referring to FIGS. 1 and 2, the battery module 100 according to this embodiment includes two or more battery cells 10, a housing 150 and a sub cover 120. The two or more battery cells 10 are arranged in one direction, and each battery cell 10 has a vent. The housing 150 accommodates the battery cells 10, and has a top cover 130. The sub cover 120 is provided to cover at least one portion of tops of the battery cells 10, and allows the battery cell 10 and the top cover 130 to be spaced apart from each other.

Here, the housing 150 includes a bottom cover fastened to the top cover 130 so as to accommodate battery cells 10.

The top cover 130 includes a top cover plate 131 that substantially covers the top surfaces of the battery cells 10, a fastening plate 133 having a top cover fastening hole 135 formed therein so as to be fastened to the bottom cover 140, and a fastening member 136 that fastens the top and bottom covers 130 and 140 to each other. The bottom cover 140 includes a bottom cover plate 141 that substantially accommodates the battery cells 10 and having a bottom cover fastening hole 145 formed therein so as to be fastened to the top cover 130, a bottom cover projection 147 protruded on a bottom surface of the bottom cover plate 141, which faces the bottom surface of the battery cell 10, and a connection plate 149 connected to an adjacent battery module 100.

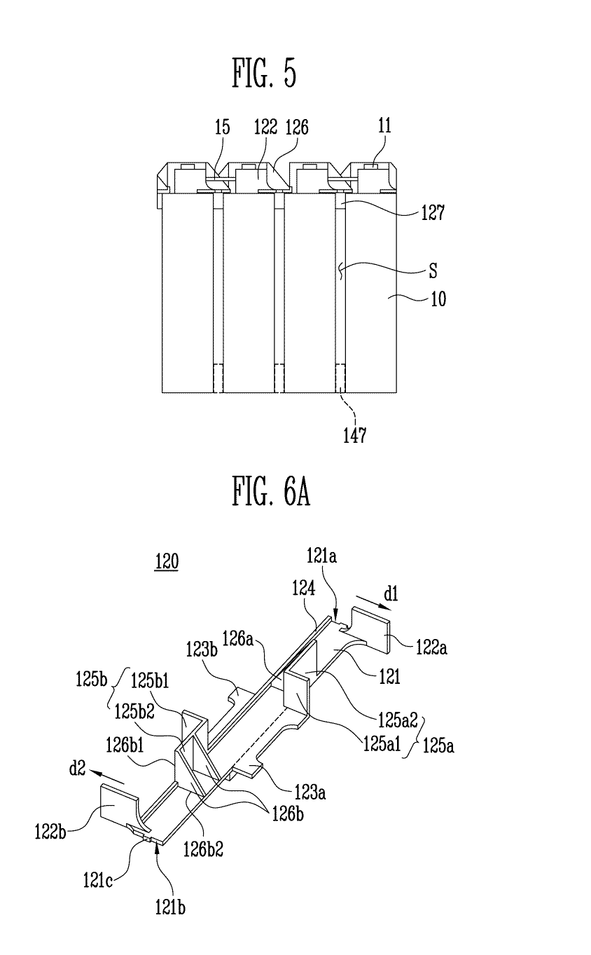

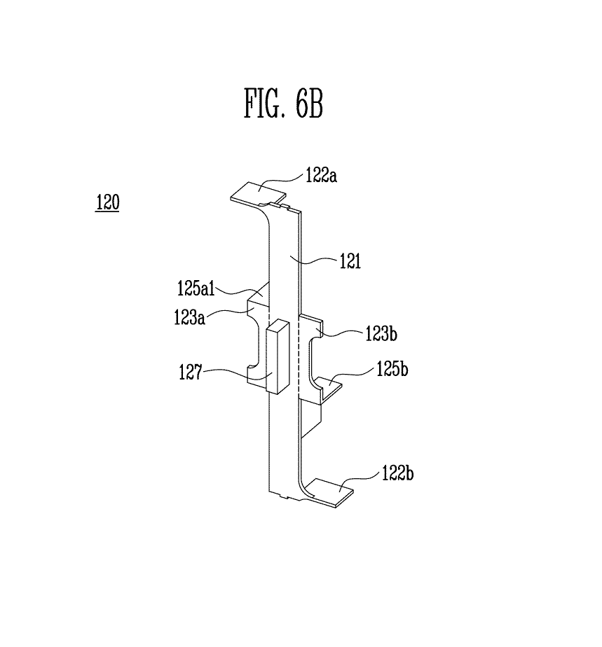

Referring to FIG. 3, an opening 141c that comprises, in one embodiment, a hook fastening portion and a through-hole portion 148 are further formed in a side surface of the bottom cover 140, corresponding to a narrow side surface of the battery cell 10. Here, the opening 141c is formed at a position corresponding to a projection portion 121c which, in one embodiment, comprises a hook (see FIG. 6A) of the sub cover 120, which will be described later, so as to be fastened to the projection portion, and the through-hole portion 148 exposes a separate space S (see FIG. 5) between adjacent battery cells 10. In a case where the through-hole portion 148 is formed to have a width smaller than that of the separate space S, the area through which heat generated from the battery cell 10 can be radiated becomes narrow. Therefore, the through-hole portion 148 is preferably formed to have a sufficiently large width so that a portion of the adjacent battery cell 10 is exposed or to have a width equal to that of the separate space S. The bottom cover projection 147 provided in the separate space S so as to allow the adjacent battery cells 10 to be spaced apart from each other is formed on a bottom surface of the bottom cover plate 141. The bottom cover projection 147 and a projection 127 of the sub cover 120, which will be described later, may be provided opposite to each other in the separate space S, so as to act as a barrier that allows the adjacent battery cells 10 to be spaced apart from each other.

According to this embodiment, the sub cover 120 is provided to the top of the battery cell 10. The sub cover 120 allows the battery cell 10 and the top cover 130 to be spaced apart from each other, so that gas or heat generated from the battery cell 10 can be easily discharged without a conventional vent cover.

The sub cover 120 is provided with an insulating rib 122 formed at a portion contacting the bottom plate 140, so that it is possible to enhance the insulation property between the battery cell 10 and the bottom plate 140. Although the sub cover 120 may be made of a polymer or plastic material having no conductivity but rigidity, the material of the sub cover 120 is not limited thereto. The sub cover 120 will be described later in detail with reference to FIGS. 6A and 6B.

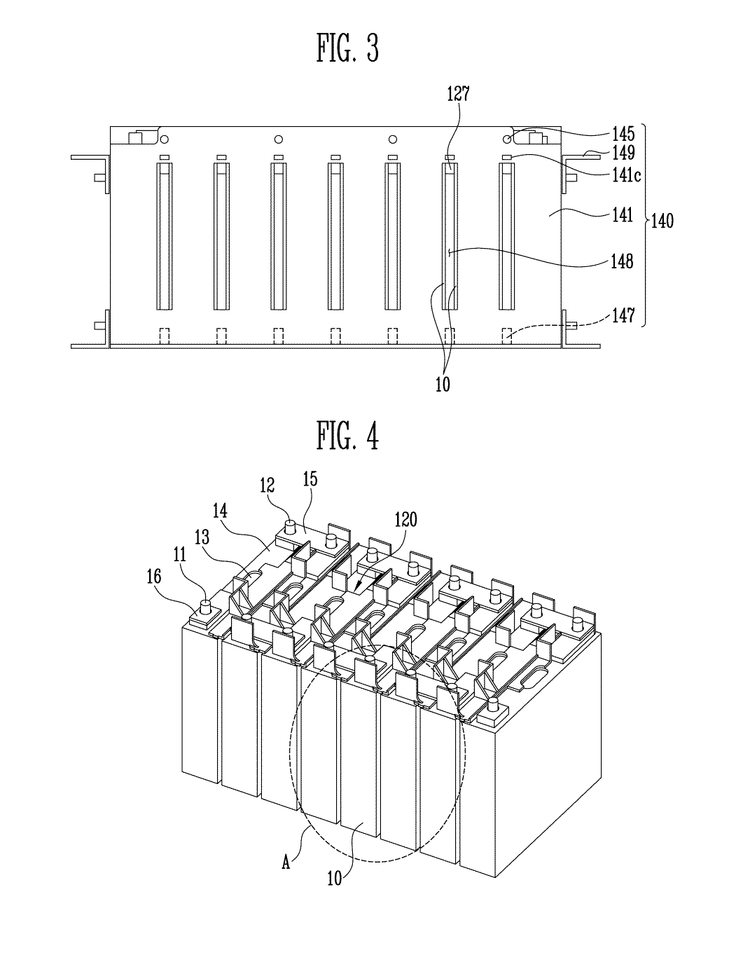

FIG. 4 is a perspective view of the battery module excluding the housing according to the embodiment of the present invention. FIG. 5 is a side view of portion A in FIG. 4. FIG. 6A is a perspective view of the sub cover enlarged in one direction according to the embodiment of the present invention. FIG. 6B is a perspective view of the sub cover enlarged in another direction according to the embodiment of the present invention.

Referring to FIG. 4, each battery cell 10 may include a battery case having an opened portion and a cap plate 14 that seals the opened portion. The battery case may accommodate an electrode assembly and an electrolyte. Here, the electrode assembly is composed of a positive electrode plate, a negative electrode plate and a separator interposed between the electrode plates. Positive and negative electrode terminals 11 and 12 connected to the positive and negative electrode plates are protruded to outsides from both ends of the cap plate 14, respectively. The positive and negative electrode plates constituting the electrode assembly generate energy by reacting with the electrolyte, and the generated energy is provided to the outside of the battery cell 10 through the positive and negative electrode terminals 11 and 12.

In a case where the pressure of the gas generated in the battery cell 10 is a predetermined value or more, a vent portion 13 provided between the positive and negative electrode terminals 11 and 12 of the cap plate 14 may act as a passage through which the gas is exhausted from the battery cell 10. Thus, the vent portion 13 prevents the battery cell 10 from being broken by the internal pressure.

According to this embodiment, a plurality of battery cells 10 may be provided to be arranged in one direction. In this case, the battery cells 10 are arranged in parallel so that wide side surfaces of the battery cells 10 face each other. The vent portion 13 is provided at a central portion of each battery cell 10, and the vent portions 13 are disposed on an approximately straight line along the arranged battery cells 10. The positive and negative electrode terminals 12 of two adjacent battery cells 10 may be electrically connected through a bus-bar 15 formed of metal. High-current terminals 16 of both the outermost battery cells 10 are not fastened to the bus-bar 15, and high current is transferred from both the outermost battery cells 10.

Referring to FIG. 5, the separate space S may be primarily formed by adjusting the length of the bus-bar 15 that connects the positive and negative electrode terminals 11 and 12 of adjacent battery cells 10. The separate space S is formed between the adjacent battery cells 10 so that heat generated from the battery cells 10 can be more easily discharged. However, the bus-bar is fastened only at the top of the battery cell 10, and therefore, the separate space S may be unstably formed. On the other hand, according to this embodiment, the projection 127 is formed on the sub cover 120 which will be described later, so that the separate space S can be maintained. The bottom cover projection 147 is formed on the bottom surface of the bottom cover plate 141 so as to face the projection 127 in the separate space S, so that the separate space S can be more stably maintained.

Referring to FIGS. 5 to 6B, the sub cover 120 is provided with a base plate 121 formed in an approximately rectangular shape having a first and second side, and an insulating rib 122 provided on the base plate 121 and formed at a portion contacting the bottom plate 140 (see FIG. 2). The insulating rib 122 is provided to form a predetermined angle (approximately 90 degrees) with the base plate 121. The insulating rib 122 may be composed of a first insulating rib 122a provided at one end 121a of the base plate 121 and a second insulating rib 122b provided at the other end 121b of the base plate 121. The first insulating rib 122a may be protruded in a first direction d1 with respect to the base plate 121, and the second insulating rib 122b may be protruded in a second direction d2 that is a direction opposite by 180 degrees to the first direction d1.

The sub cover 120 includes a vent rib 123 provided in parallel with the base plate 121 around the vent portion 13 (see FIG. 4). The vent rib 123 may be composed of a first vent rib 123a protruded in the first direction d1 with respect to the base plate 121 and a second vent rib 123b protruded in the second direction d2 with respect to the base plate 121. The first and second vent ribs 123a and 123b are provided not to cover the vent portion 13.

The sub cover 120 further includes a support rib 125 disposed between the vent rib 123 and the insulating rib 122 on the second side. The support rib 125 is composed of a first support rib 125a connected to the first vent rib 123a and a second support rib 125b connected to the second vent rib 123b. Here, one portion 125a1 of the first support rib 125a forms a predetermined angle (approximately 90 degrees) with the first vent rib 123a, and is protruded from the first vent rib 123a. The other portion 125a2 of the first support rib 125a forms a predetermined angle (approximately 90 degrees) with the base plate 121, and is protruded from the base plate 121. Thus, the one and the other portions 125a1 and 125a2 of the first support rib 125a are connected to form a ‘ [symbol] ’ shape.

One portion 125b1 of the second support rib 125b forms a predetermined angle (approximately 90 degrees) with the second vent rib 123b, and is protruded from the second vent rib 123b. The other portion 125b2 of the second support rib 125b forms a predetermined angle (approximately 90 degrees) with the base plate 121, and is protruded from the base plate 121. Thus, the one and the other portions 125b1 and 125b2 of the second support rib 125b are connected to form a ‘ [symbol] ’ shape.

The sub cover 120 further includes a reinforcing rib 126 on the second side in this embodiment. The reinforcing rib 126 is provided between the insulating rib 122 and the vent rib 123, and forms a predetermined angle (approximately 90 degrees) with the base plate 121 or the support rib 125 so as to connect between the base plate 121 and the support rib 125. Here, the reinforcing rib 126 is composed of a first reinforcing rib 126a provided to contact the first support rib 125a and a second reinforcing rib 126b provided to contact the second support rib 125b. The first and second reinforcing ribs 126a and 126b function to reinforce the rigidities of the first and second support ribs 125a and 125b, respectively. One end (not shown) of the first reinforcing rib 126a contacts the first support rib 125a so as to form a predetermined angle (approximately 90 degrees) with the first support rib 125a. The other end (not shown) of the first reinforcing rib 126a contacts the base plate 121 so as to form a predetermined angle (approximately 90 degrees) with the base plate 121. One end 126b1 of the second reinforcing rib 126b contacts the second support rib 125b so as to form a predetermined angle (approximately 90 degrees) with the second support rib 125b. The other end 126b2 of the second reinforcing rib 126b contacts the base plate 121 so as to form a predetermined angle (approximately 90 degrees) with the base plate 121. As shown in FIG. 6A, the second reinforcing rib 126b may be provided so that two second reinforcing ribs are spaced apart from each other at the other portion 125b2 of the second support rib 125b. However, the present is not limited thereto, and the second reinforcing rib 126b may be provided to have various numbers and intervals.

Meanwhile, the sub cover 120 may further include an anti-bending rib 124 protruded along the long side of the base plate 121 on the second side so as to form approximately 90 degrees with the base plate. The anti-bending rib 124 can provide rigidity to the base plate 121 that may be easily bent in the direction of the long side thereof.

The projection portions 121c may be provided to the one and the other ends 121a and 121b of the base plate 121, respectively. The projection portions 121c are fastened to the opening 141c formed in the side surface of the bottom cover 140 (see FIG. 2), so that the sub cover 120 can be stably coupled to the housing 150.

The insulating rib 122 and the support rib 125, which are provided to the sub cover 120, are preferably formed to have the same height so that the interval between the battery cell 10 and the top cover 130 can be stably maintained. The anti-bending rib 124 provides the rigidity to the base plate 121 that may be easily bent in the direction of the long side thereof, and the height of the anti-bending rib 124 may be formed lower than that of the insulating rib 122. Meanwhile, the thicknesses of the insulating rib 122, the support rib 125, the reinforcing rib 126 and the anti-bending rib 124 may not be equally formed. However, the thickness of each of the insulating rib 122, the support rib 125, the reinforcing rib 126 and the anti-bending rib 126 is preferably formed thicker than that of the base plate 121 so that it is possible to stably maintain the interval between the battery cell 10 and the top cover 130 and to maintain the rigidity of the sub cover 120.

Referring to FIGS. 5 and 6B, the projection 127 is provided on the first side of the base plate 121 provided with the support rib 125, the reinforcing rib 126 and the anti-bending rib 124. The projection 127 provided to the sub cover 120 is provided to face the bottom cover projection 147 provided on the bottom surface of the bottom cover plate 141 (see FIG. 5) in the separate space S, so that the projection 127 and the bottom cover projection 147 can act as a barrier that allows the adjacent battery cells 10 to be spaced apart from each other. Here, the separate space S is a space formed between adjacent battery cells 10.

Since the bottom cover projection 147 and the projection 127 provided to the sub cover 120 can allow the adjacent battery cells 10 to be spaced apart from each other, the battery module 100 according to this embodiment enables the heat generated from the battery cells 10 to be easily discharged without using a separate barrier.

The sub cover 120 is provided to the top of the battery cell 10. The sub cover 120 allows the battery cell 10 and the top cover 130 to be spaced apart from each other, so that gas or heat generated from the battery cell 10 can be easily discharged without the conventional vent cover.

The sub cover 120 is provided with the insulating rib 122 at the portion contacting the bottom plate 140, so that it is possible to enhance the insulation property between the battery cell 10 and the bottom plate 140.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A battery module comprising:
a plurality of battery cells having a length, a width, a first surface and a vent formed in the first surface;
a housing having side walls that defines a recess having a length and a width wherein the recess receives the plurality of battery cells;
a top cover that is positioned on the first housing member so as to cover the recess; and
at least one sub-cover having a first and a second side that extends over at least some of the first surface of the plurality of battery cells wherein the at least one sub-cover includes a protrusion formed on the first side that is interposed between adjacent battery cells positioned within the recess so as to define a space between adjacent battery cells.

2. The module of claim 1, wherein the at least one sub-cover comprises a plurality of sub-covers such that a sub-cover is positioned adjacent each of the plurality of battery cells.

3. The module of claim 1, wherein the at least one sub-cover comprises an approximately rectangular base plate that has a width and a length and wherein the plate is positioned over at least one of the battery cells so that the length of the plate extends in the same direction as the length of the at least one of the battery cells.

4. The module of claim 3, wherein the at least one sub-cover includes at least one insulating rib that is positioned at an end of the length of the sub-cover, wherein the at least one insulating rib is positioned adjacent at least one of the side walls of the housing.

5. The module of claim 4, wherein the at least one insulating rib comprises a first insulating rib and a second insulating rib that extend in a first direction and a second direction, respectively, from the ends of the length of the base plate so as to be interposed between one of the battery cells and the side walls of the housing.

6. The module of claim 3, wherein the at least one sub-cover includes at least one vent rib that extends outward from the base plate and wherein the vent rib is contoured to extend around the vent of the at least one battery cell so that the vent is exposed when the at least one sub-cover is positioned over the at least one battery cell.

7. The module of claim 6, wherein the at least one sub-cover comprises a plurality of sub-covers having vent ribs and wherein the plurality of sub-covers are positioned within the housing so that the vent ribs on at least some adjacent sub-covers form an opening having a contour that substantially conforms to the contour of the vent of the battery cell positioned beneath the adjacent sub-covers.

8. The module of claim 6, wherein the at least one vent rib comprises a first and second vent rib that extend outward from the base plate in a first and a second direction respectively.

9. The module of claim 6, wherein the sub-cover includes at least one support rib respectively wherein at least a portion of the at least one support rib is positioned on the at least one vent rib that extends outward from the plane of the at least one vent rib and the second side of the base plate.

10. The module of claim 9, wherein the at least one vent rib comprises a first and a second vent rib and the at least one support rib comprises a first and a second support rib that is positioned on a first and second vent ribs respectively.

11. The module of claim 9, wherein the at least one support rib comprises a first portion that extends outward from the second side of the base plate in the direction of the at least one vent rib and a second portion that extends in a substantially perpendicular direction to the first portion along the length of the base plate.

12. The module of claim 11, wherein the base plate includes at least one reinforcing member that extends from the at least one support rib to the second side of the base plate.

13. The module of claim 12, wherein the at least one reinforcing member comprises a first and a second reinforcing member.

14. The module of claim 11, wherein the at least one reinforcing member extends from the second portion of the support rib to the base plate.

15. The module of claim 3, wherein the sub-cover includes an anti-bending rib that extends along the length of the base plate to inhibit bending of the base plate along the length.

16. The module of claim 1, wherein the sub-cover includes at least one projection portion and the housing includes at least one opening formed in one of the side walls of the housing that receives the at least one projection portion to secure the sub-cover within the recess.

17. The module of claim 15, wherein the at least one projection portion comprises a first and a second projection portion and the at least one opening comprises a first and a second opening so that the lengthwise ends of the at least one sub-cover are secured to the side walls of the housing.

18. The module of claim 1, wherein the housing includes a bottom plate that has projections that extend toward the projections of the at least one sub-cover so that the projections on the bottom plate and the projections on the at least one sub-cover define the space that separates the adjacent battery cells.

19. The module of claim 1, wherein the at least one sub-cover is interposed between the at least one battery cell and the top cover.

20. The module of claim 1, wherein at least some of the side walls of the housing define openings that are aligned with the space between the adjacent battery cells.
